(19) United States
(12) Patent Application Publication
(10) Pub. No.: US 2026/0264844 A1
(43) Pub. Date: Sep. 10, 2026

(54) FLUID SYSTEM AND FLYING OBJECT

(71) Applicant: HONDA MOTOR CO., LTD., Tokyo (JP)

(72) Inventor: Norikazu Kawai, Wako-shi (JP)

(21) Appl. No.: 19/557,941

(22) Filed: Mar. 5, 2026

(30) Foreign Application Priority Data
Mar. 10, 2025 (JP) 2025-037107

(51) Int. Cl. B64C 11/38; B64D 27/30; B64D 33/08

(52) U.S. Cl. CPC B64C 11/38; B64D 27/30; B64D 33/08

(57) ABSTRACT

A fluid system includes: a hydraulic circuit configured to supply liquid under pressure to a variable pitch mechanism configured to change the pitch angle of a blade provided in a propeller; and a coolant circuit configured to supply liquid for cooling to an electric motor configured to rotate the propeller. Liquid is supplied to the hydraulic circuit and the coolant circuit from a liquid supply unit shared by the hydraulic circuit and the coolant circuit.

### CROSS-REFERENCE TO RELATED APPLICATIONS

This application is based upon and claims the benefit of priority from Japanese Patent Application No. 2025-037107 filed on March 10, 2025, the contents of which are incorporated herein by reference.

### BACKGROUND OF THE INVENTION

### FIELD OF THE INVENTION

The present disclosure relates to a fluid system and a flying object.

### DESCRIPTION OF THE RELATED ART

US 10875640 B2 discloses an aircraft in which a propeller can be locked by moving a piston by means of hydraulic oil. In an aircraft, a large number of fluid systems each including a flow path through which liquid such as hydraulic oil flows are formed.

### SUMMARY OF THE INVENTION

There has been a demand for a more suitable fluid system.

The present disclosure has the object of solving the above-described problem.

One aspect of the present disclosure is characterized by a fluid system comprising: a hydraulic circuit configured to supply liquid under pressure to a variable pitch mechanism configured to change a pitch angle of a blade provided in a propeller; and a coolant circuit configured to supply liquid to an electric motor configured to rotate the propeller, wherein liquid is supplied to the hydraulic circuit and the coolant circuit from a liquid supply unit shared by the hydraulic circuit and the coolant circuit.

Another aspect of the present disclosure is characterized by a flying object comprising the fluid system according to the one aspect.

According to the present disclosure, a more suitable fluid system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a flying object; and

FIG. 2 is a fluid circuit diagram of a fluid system.

### DETAILED DESCRIPTION OF THE INVENTION

In a flying object, in order to secure a cruising distance, it is desired to reduce the size and weight of various parts and various systems. According to the disclosure of the present specification, it is possible to realize a reduction in size and weight of a system formed of a plurality of liquid circuits each including a flow path through which liquid flows.

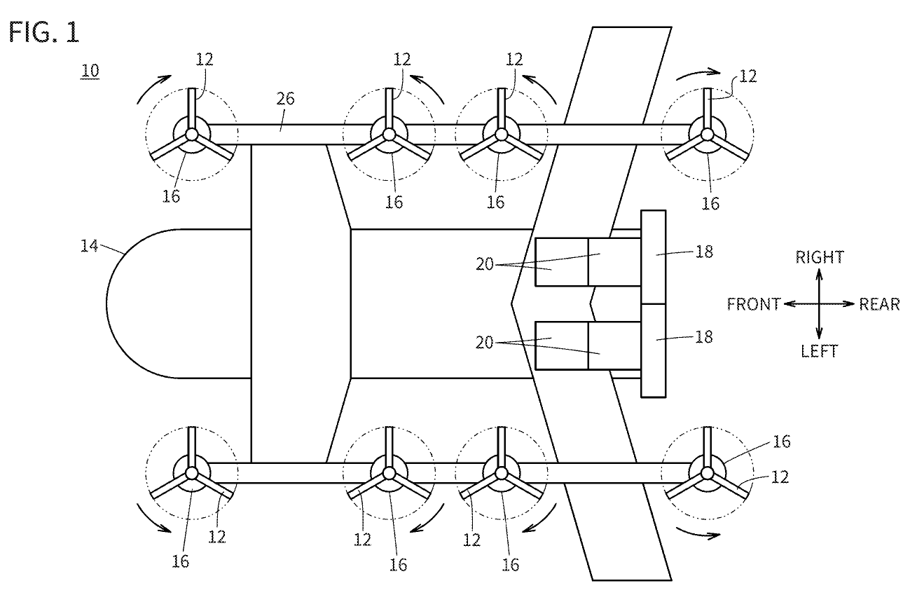

FIG. 1 is a schematic diagram of a flying object 10. The flying object 10 is an electric vertical take-off and landing aircraft. The flying object 10 includes eight VTOL rotors (propellers) 12. The VTOL rotors 12 generate upward thrust for a fuselage 14. The flying object 10 includes eight electric motors 16. One electric motor 16 drives one VTOL rotor 12. The flying object 10 includes two cruise rotors 18. The cruise rotors 18 generate forward thrust for the fuselage 14. The flying object 10 includes four electric motors 20. Two electric motors 20 drive one cruise rotor 18.

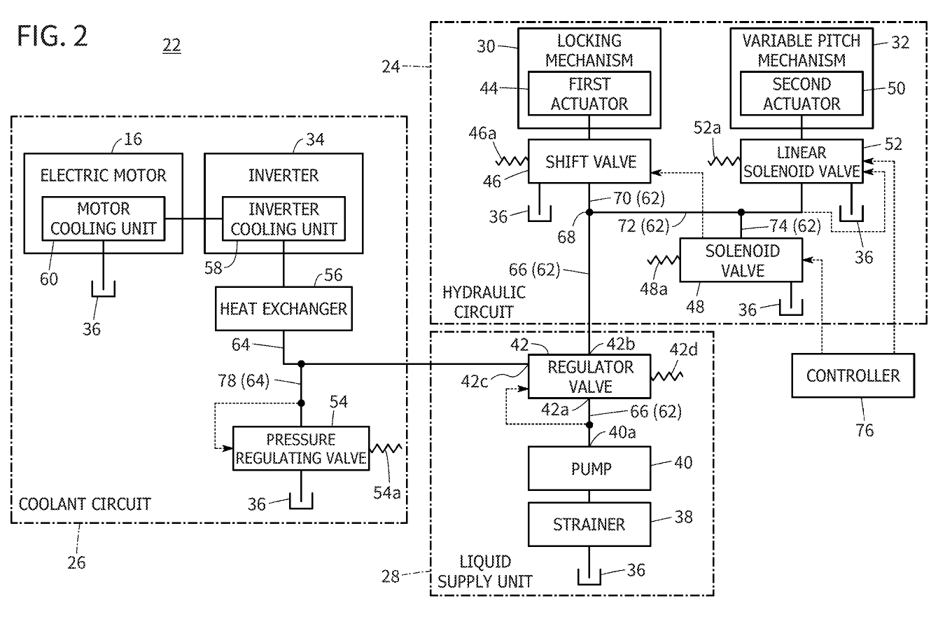

FIG. 2 is a fluid circuit diagram of a fluid system 22. The fluid circuit diagram shown in FIG. 2 is schematically illustrated. The fluid system 22 is provided in the flying object 10 shown in FIG. 1. The fluid used in the fluid system 22 is liquid such as oil.

The fluid system 22 is a composite system in which two circuits having different purposes of use of the liquid are combined. Specifically, the fluid system 22 includes a hydraulic (liquid pressure) circuit 24 and a coolant circuit 26. In the hydraulic circuit 24, the liquid is used as a force transfer medium. The hydraulic circuit 24 operates actuators by supplying pressurized liquid (liquid under pressure) to the actuators. In the coolant circuit 26, the liquid is used as a heat transfer medium. The coolant circuit 26 cools a device by supplying the liquid for cooling to a flow path in contact with the device.

The hydraulic circuit 24 supplies operating pressure to a locking mechanism 30 and a variable pitch mechanism 32. The locking mechanism 30 fixes the VTOL rotor 12 by locking the shaft of the VTOL rotor 12. For example, the locking mechanism 30 fixes a pin member provided on the shaft with a movable block member. The variable pitch mechanism 32 changes the pitch angle of a plurality of blades provided in the VTOL rotor 12 (FIG. 1). On the other hand, the coolant circuit 26 cools the electric motor 16 that rotates the VTOL rotor 12, and an inverter 34 that supplies electric power to the electric motor 16. In this manner, both the hydraulic circuit 24 and the coolant circuit 26 are associated with the VTOL rotor 12. Therefore, the hydraulic circuit 24 and the coolant circuit 26 are formed around the VTOL rotor 12.

The fluid system 22 includes a liquid supply unit 28. The liquid supply unit 28 is configured to supply liquid to the hydraulic circuit 24 and the coolant circuit 26. In other words, the hydraulic circuit 24 and the coolant circuit 26 share the liquid supply unit 28. According to such a configuration, it is not necessary to individually provide the liquid supply unit 28 in each circuit. Accordingly, the number of parts of the fluid system 22 is reduced, and the fluid system 22 is reduced in weight.

The liquid supply unit 28 includes a tank 36, a strainer 38, a pump 40, and a regulator valve 42. The hydraulic circuit 24 includes a first actuator 44, a shift valve 46, a solenoid valve 48, a second actuator 50, and a linear solenoid valve 52. The coolant circuit 26 includes a pressure regulating valve 54, a heat exchanger 56, an inverter cooling unit 58, and a motor cooling unit 60.

The fluid system 22 includes a high-pressure flow path 62 through which relatively high pressure liquid flows, and a low-pressure flow path 64 through which relatively low pressure liquid flows. The high-pressure flow path 62 includes a main flow path 66, a first branch flow path 70 connected to the main flow path 66 at a branch point 68, and a second branch flow path 72 connected to the main flow path 66 at the branch point 68.

The tank 36 stores liquid. The pump 40 pressurizes the liquid sucked from the tank 36 and discharges the pressurized liquid to the main flow path 66. A discharge port 40a of the pump 40 is connected to a hydraulic (liquid pressure) chamber of the first actuator 44 via the main flow path 66 and the first branch flow path 70. Further, the discharge port 40a of the pump 40 is connected to a hydraulic chamber of the second actuator 50 via the main flow path 66 and the second branch flow path 72. The regulator valve 42 is disposed in the main flow path 66. The shift valve 46 is disposed in the first branch flow path 70. The linear solenoid valve 52 is disposed in the second branch flow path 72. A third branch flow path 74 branches off from the second branch flow path 72. The solenoid valve 48 is disposed in the third branch flow path 74.

The first actuator 44 is a component of the locking mechanism 30. The first actuator 44 includes, for example, the hydraulic chamber and a piston rod. The piston rod is connected to the block member for the VTOL rotor 12. When the liquid is supplied to the hydraulic chamber, the piston rod is pushed by the liquid and moves in a first direction. On the other hand, when the liquid is discharged from the hydraulic chamber, the piston rod is pushed by a spring and moves in a second direction. The position of the block member is determined according to the movement position of the piston rod.

The second actuator 50 is a component of the variable pitch mechanism 32. The second actuator 50 includes, for example, the hydraulic chamber and a piston rod. The piston rod is connected to the blades of the VTOL rotor 12. When the liquid is supplied to the hydraulic chamber, the piston rod is pushed by the liquid and moves in the first direction. On the other hand, when the liquid is discharged from the hydraulic chamber, the piston rod is pushed by a spring and moves in the second direction. The pitch angle of the blades is determined according to the movement position of the piston rod.

The regulator valve 42 is configured to regulate the pressure of the liquid flowing through the main flow path 66, and is also configured to supply the liquid to the low-pressure flow path 64. The regulator valve 42 includes a first port 42a for taking in the liquid discharged from the pump 40, a second port 42b for discharging the liquid whose pressure has been regulated, and a third port 42c for discharging the liquid for the pressure regulation. The first port 42a is connected to an upstream portion of the main flow path 66. The second port 42b is connected to a downstream portion of the main flow path 66. The third port 42c is connected to an upstream portion of the low-pressure flow path 64. The regulator valve 42 causes the liquid whose pressure has been regulated to a constant first pressure to be discharged to the downstream side of the main flow path 66 via the second port 42b. Further, the regulator valve 42 causes the liquid, which is no longer required due to the pressure regulation, to be discharged to the low-pressure flow path 64 via the third port 42c. Note that the first pressure is determined according to a spring 42d and the pressure receiving area of the valve element. The regulator valve 42 adjusts the opening degree of the third port 42c in accordance with a difference between a pressing force acting on the valve element by means of the liquid flowing on the primary side (the liquid on the inflow side), and a pressing force of the spring 42d acting on the valve element.

The flow rate of the liquid supplied to the low-pressure flow path 64 is determined according to the discharge amount of the pump 40. In order to stably supply the liquid to the low-pressure flow path 64, it is preferable to adjust the discharge amount of the pump 40 to an appropriate amount.

The shift valve 46 brings the first branch flow path 70 into a communication state or a blocked state. The pressure of the liquid supplied from the solenoid valve 48 (pilot pressure) and a pressing force of a spring 46a act on the valve element of the shift valve 46. In the case where the liquid is supplied to the shift valve 46 via the solenoid valve 48, the valve element of the shift valve 46 moves to a first position, and the first branch flow path 70 is brought into the communication state. On the other hand, in the case where the liquid is not supplied to the shift valve 46 via the solenoid valve 48, the valve element of the shift valve 46 moves to a second position, and the first branch flow path 70 is brought into the blocked state. Note that, in the case where the valve element of the shift valve 46 moves to the second position, the hydraulic chamber of the first actuator 44 and the tank 36 communicate with each other.

The solenoid valve 48 is configured to cause pilot pressure liquid to be supplied to the shift valve 46. A pressing force generated by the solenoid and a pressing force of a spring 48a act on the valve element of the solenoid valve 48. The solenoid of the solenoid valve 48 is energized by a controller 76. The controller 76 includes, for example, a processor such as a CPU, and a power supply circuit. In the case where the solenoid of the solenoid valve 48 is energized, the solenoid valve 48 causes the pilot pressure liquid to be supplied to the shift valve 46. On the other hand, in the case where the solenoid of the solenoid valve 48 is not energized, the solenoid valve 48 does not cause the pilot pressure liquid to be supplied to the shift valve 46.

The linear solenoid valve 52 controls the second branch flow path 72 at an arbitrary pressure from the blocked state. A pressing force generated by the solenoid, the pressure of the liquid in the second branch flow path 72, and a pressing force of a spring 52a act on the valve element of the linear solenoid valve 52. The pressure of the liquid discharged from the linear solenoid valve 52 is configured to be arbitrarily set by the voltage applied to the linear solenoid valve 52 by the controller 76. As a result, the second actuator 50 is controlled to be located at an arbitrary position. That is, by controlling the voltage applied to the linear solenoid valve 52, the pitch angle of the blades of the VTOL rotor 12 shown in FIG. 1 can be controlled.

The third port 42c of the regulator valve 42 is connected to the tank 36 via the low-pressure flow path 64. The heat exchanger 56, the inverter cooling unit 58, and the motor cooling unit 60 are disposed in the low-pressure flow path 64. The heat exchanger 56 is disposed upstream of the inverter cooling unit 58 and the motor cooling unit 60. The inverter cooling unit 58 is disposed upstream of the motor cooling unit 60. The temperature of the liquid for cooling the inverter 34 is controlled to a temperature lower than that of the electric motor 16. As in the present embodiment, by disposing the inverter cooling unit 58 upstream of the motor cooling unit 60, the inverter 34 can be further cooled. A fourth branch flow path 78 branches off from a portion of the low-pressure flow path 64 that is located upstream of the heat exchanger 56. The fourth branch flow path 78 is connected to the tank 36. The pressure regulating valve 54 is disposed in the fourth branch flow path 78.

The pressure regulating valve 54 regulates the pressure of the liquid flowing through the low-pressure flow path 64. In the case where the pressure of the liquid flowing through the low-pressure flow path 64 is lower than a second pressure that is lower than the first pressure, the pressure regulating valve 54 brings the fourth branch flow path 78 into the blocked state. On the other hand, in the case where the pressure of the liquid flowing through the low-pressure flow path 64 is equal to or higher than the second pressure, the pressure regulating valve 54 brings the fourth branch flow path 78 into the communication state. As a result, the liquid is discharged from the fourth branch flow path 78 to the tank 36. Then, the pressure of the liquid flowing through the fourth branch flow path 78 decreases. In this manner, the pressure regulating valve 54 regulates the pressure of the liquid flowing through the low-pressure flow path 64 to the second pressure that is lower than the first pressure. Note that the second pressure is determined according to a spring 54a and the pressure receiving area of the valve element. The pressure regulating valve 54 adjusts the opening degree in accordance with a difference between a pressing force acting on the valve element by means of the liquid flowing on the primary side (the liquid on the inflow side) and a pressing force of the spring 54a acting on the valve element.

The heat exchanger 56 cools liquid. For example, the heat exchanger 56 is a radiator including a flow path through which the liquid flows, and heat dissipation fins connected to the flow path. The heat exchanger 56 exchanges heat between the liquid and the outside air. As a result, the heat exchanger 56 releases the heat of the liquid to the outside air.

The inverter cooling unit 58 includes a flow path disposed along the substrate of the inverter 34. The liquid flowing through the inverter cooling unit 58 cools the inverter 34 by absorbing heat from the inverter 34.

The motor cooling unit 60 includes a flow path disposed along the coil of the electric motor 16. The liquid flowing through the motor cooling unit 60 cools the coil of the electric motor 16 by absorbing heat from the coil of the electric motor 16.

In the fluid system 22, the liquid flows as follows. The pressure of the liquid discharged from the pump 40 is regulated by the regulator valve 42. In the case where the first branch flow path 70 is being brought into the communication state by the shift valve 46, the liquid discharged from the second port 42b of the regulator valve 42 flows through the main flow path 66 and the first branch flow path 70 and is supplied to the first actuator 44 provided in the locking mechanism 30. In the case where the second branch flow path 72 is being brought into the communication state by the linear solenoid valve 52, the liquid discharged from the second port 42b of the regulator valve 42 flows through the main flow path 66 and the second branch flow path 72 and is supplied to the second actuator 50 provided in the variable pitch mechanism 32. The liquid discharged from the third port 42c of the regulator valve 42 flows through the low-pressure flow path 64 and is discharged into the tank 36. Before being discharged into the tank 36, the liquid releases heat in the heat exchanger 56 and absorbs heat in the inverter cooling unit 58 and the motor cooling unit 60.

The pressure of the liquid flowing through the low-pressure flow path 64 is regulated to the second pressure by the pressure regulating valve 54. According to such a configuration, it is possible to suppress damage to the respective flow paths (the heat exchanger 56, the inverter cooling unit 58, and the motor cooling unit 60) in the coolant circuit 26, and to their peripheral devices (the inverter 34 and the electric motor 16).

The following supplementary notes are further disclosed in relation to the above-described embodiment.

### Supplementary Note 1

The fluid system (22) of the present disclosure includes: the hydraulic circuit (24) configured to supply liquid under pressure to the variable pitch mechanism (32) configured to change the pitch angle of the blade provided in the propeller (12); and the coolant circuit (26) configured to supply liquid to the electric motor (16) configured to rotate the propeller, wherein liquid is supplied to the hydraulic circuit and the coolant circuit from the liquid supply unit (28) shared by the hydraulic circuit and the coolant circuit.

According to the above configuration, it is not necessary to individually provide the liquid supply unit in each circuit. Therefore, the number of parts of the fluid system is reduced, and the fluid system is reduced in weight.

### Supplementary Note 2

In the fluid system according to Supplementary Note 1, the liquid supply unit may include the tank (36) configured to store liquid, the pump (40) configured to pressurize liquid sucked from the tank and discharge the liquid, and the regulator valve (42) configured to regulate the pressure of liquid supplied from the pump to the hydraulic circuit to the first pressure, and configured to supply liquid to the coolant circuit.

### Supplementary Note 3

In the fluid system according to Supplementary Note 2, the coolant circuit may include the valve (54) configured to regulate the pressure of liquid supplied from the regulator valve to the coolant circuit to the second pressure that is lower than the first pressure.

According to the above configuration, it is possible to suppress damage to the respective flow paths in the coolant circuit, and to their peripheral devices.

### Supplementary Note 4

The flying object (10) of the present disclosure includes the fluid system according to any one of Supplementary Notes 1 to 3.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A fluid system comprising:
a hydraulic circuit configured to supply liquid under pressure to a variable pitch mechanism configured to change a pitch angle of a blade provided in a propeller; and
a coolant circuit configured to supply liquid to an electric motor configured to rotate the propeller,
wherein liquid is supplied to the hydraulic circuit and the coolant circuit from a liquid supply unit shared by the hydraulic circuit and the coolant circuit.

2. The fluid system according to claim 1, wherein
the liquid supply unit includes:
a tank configured to store liquid;
a pump configured to pressurize liquid sucked from the tank and discharge the liquid; and
a regulator valve configured to regulate a pressure of liquid supplied from the pump to the hydraulic circuit to a first pressure and to supply liquid to the coolant circuit.

3. The fluid system according to claim 2, wherein
the coolant circuit includes a valve configured to regulate a pressure of liquid supplied from the regulator valve to the coolant circuit to a second pressure that is lower than the first pressure.

4. A flying object comprising the fluid system according to claim 1.

5. A fluid system comprising:
a hydraulic circuit configured to supply liquid under pressure to a variable pitch mechanism configured to change a pitch angle of a blade provided in a propeller;
a coolant circuit configured to supply liquid to an electric motor configured to rotate the propeller; and
a liquid supply unit including
a tank configured to store liquid,
a pump configured to pressurize liquid sucked from the tank and discharge the liquid, and
a regulator valve configured to regulate a pressure of liquid supplied to the hydraulic circuit to a first pressure and to supply liquid to the coolant circuit,
wherein the coolant circuit includes a valve configured to regulate a pressure of liquid supplied to the coolant circuit to a second pressure, and
wherein the first pressure is greater than the second pressure.

6. A flying object comprising the fluid system according to claim 5.
